(19) United States
(12) Patent Application Publication
(10) Pub. No.: US 2015/0361921 A1
(43) Pub. Date: Dec. 17, 2015

(54) Modifying Direct Drive Gas Turbine Engine Core to Provide a Geared Turbofan

(71) Applicant: United Technologies Corporation, Hartfored, CT (US)

(72) Inventors: Frederick M. Schwarz, Glastonbury, CT (US); Joseph Brent Staubach, Colchester, CT (US)

(21) Appl. No.: 14/711,861

(22) Filed: May 14, 2015

Related U.S. Application Data
(60) Provisional application No. 62/011,636, filed on Jun. 13, 2014.
(60) Provisional application No. 62/012,593, filed on Jun. 16, 2014.

(51) Int. Cl. F02K 3/02; F02K 3/075; F02K 3/065

(52) U.S. Cl. CPC F02K 3/025; F02K 3/065; F02K 3/075; F05D 2230/80

(57) ABSTRACT

A method comprises the steps of modifying a direct drive engine, which includes a first fan rotor, a high pressure compressor driven by a high pressure turbine on a first high spool and a first low pressure turbine designed to drive a first low pressure compressor on a first low spool, and the fan rotor all at the same speed. The modifying step includes providing a second fan rotor, second low spool, including a second low pressure compressor rotor and second low pressure turbine rotor and incorporating a gear reduction between a shaft driven by the second low pressure turbine rotor and the second fan rotor to provide a geared turbofan, such that at least a portion of the design of the high pressure compressor rotor, the combustor and the high pressure turbine rotor from the designed direct drive engine are utilized in the geared turbofan. A gas turbine engine is also disclosed.

### CROSS-REFERENCE TO RELATED APPLICATION

This application claims priority to U.S. Provisional Patent Application No. 62/011,636, filed Jun. 13, 2014, and U.S. Provisional Patent Application No. 62/012,593, filed Jun. 16, 2014.

### BACKGROUND OF THE INVENTION

This application relates to the overhaul of a direct drive gas turbine engine to provide a geared gas turbine engine.

Gas turbine engines are known and, typically include a fan delivering air into a compressor core as core air flow and delivering air into a bypass duct as bypass air for propulsion. The air is compressed in the compressor and delivered into a combustion section where it is mixed with fuel and ignited. Products of this combustion pass downstream over turbine rotors driving them to rotate and to, in turn, drive the compressor and fan rotors.

In one well-developed type of gas turbine engine, a low pressure turbine rotor rotated as one with a low pressure compressor rotor and the fan rotor. This direct drive arrangement has resulted in some design constraints. In particular, it would be desirable to have the low pressure compressor rotor and the low pressure turbine rotor rotate at higher speeds relative to the fan rotor. The fan rotor, however, cannot rotate at unduly high speeds and, thus, the direct drive engines have had some limitations.

More recently, it has been proposed to incorporate a gear reduction between the low pressure turbine and the fan rotor.

On the other hand, the direct drive engines have been well developed and operational for any number of years. The design of each new geared turbofan engine will require a good deal of engineering, research, development, testing, etc.

### SUMMARY OF THE INVENTION

In a featured embodiment, a method comprises the steps of modifying a direct drive engine, which includes a first fan rotor, a high pressure compressor driven by a high pressure turbine on a first high spool and a first low pressure turbine designed to drive a first low pressure compressor on a first low spool, and the fan rotor all at the same speed. The modifying step includes providing a second fan rotor, second low spool, including a second low pressure compressor rotor and second low pressure turbine rotor and incorporating a gear reduction between a shaft driven by the second low pressure turbine rotor and the second fan rotor to provide a geared turbofan, such that at least a portion of the design of the high pressure compressor rotor, the combustor and the high pressure turbine rotor from the designed direct drive engine are utilized in the geared turbofan.

In another embodiment according to the previous embodiment, the second low spool is a complete replacement of the first low spool.

In another embodiment according to any of the previous embodiments, the second low spool is a modification of the first low spool.

In another embodiment according to any of the previous embodiments, at least one stage is removed from the direct drive high pressure compressor rotor as designed to be utilized in the geared turbofan.

In another embodiment according to any of the previous embodiments, at least one of an accessory gear box, an oil supply system and a fuel supply system is designed for the direct drive engine, and is incorporated into the geared turbofan.

In another embodiment according to any of the previous embodiments, at least a portion of each of the accessory gear box, oil supply system, and fuel supply system as designed for the direct drive engine, is utilized in the geared turbofan.

In another embodiment according to any of the previous embodiments, the second fan rotor has a diameter that is larger than the first fan rotor designed for the direct drive engine.

In another embodiment according to any of the previous embodiments, a bypass ratio for the geared turbofan is greater than or equal to about 6.0.

In another embodiment according to any of the previous embodiments, the bypass ratio is greater than or equal to about 10.0.

In another embodiment according to any of the previous embodiments, at least one of an accessory gear box, an oil supply system and a fuel supply system is designed for the direct drive engine, and is incorporated into the geared turbofan.

In another embodiment according to any of the previous embodiments, the new fan rotor has a diameter that is larger than the fan rotor designed for the direct drive engine.

In another embodiment according to any of the previous embodiments, a bypass ratio for the geared turbofan is greater than or equal to about 6.0.

In another embodiment according to any of the previous embodiments, the bypass ratio is greater than or equal to about 10.0.

In another embodiment according to any of the previous embodiment, the high pressure compressor, high pressure turbine, and a combustion section on the direct drive engine provide at least 60% of the parts, defined as also including hardware, as a high pressure compressor, high pressure turbine, and combustion section in the resulting geared turbofan.

In another featured embodiment, a gas turbine engine comprises a high pressure compressor driven by a high pressure turbine and a low pressure turbine driving a low pressure compressor and a fan rotor through a gear reduction, and a combustor. At least a portion of the high pressure compressor rotor, the combustor and the high pressure turbine rotor are from a design of a direct drive engine.

In another embodiment according to the previous embodiment, at least one stage is removed from the direct drive high pressure compressor rotor as designed to be utilized in the geared turbofan.

In another embodiment according to any of the previous embodiments, at least one of an accessory gear box, an oil supply system and a fuel supply system is designed for the direct drive engine, and is incorporated into the geared turbofan.

In another embodiment according to any of the previous embodiments, at least a portion of each of the accessory gear box, oil supply system, and fuel supply system as designed for the direct drive engine, is utilized in the geared turbofan.

In another embodiment according to any of the previous embodiments, a bypass ratio for the geared turbofan is greater than or equal to about 6.0.

In another embodiment according to any of the previous embodiments, the bypass ratio is greater than or equal to about 10.0.

In another embodiment according to any of the previous embodiments, at least one of an accessory gear box, oil supply system and a fuel supply system is designed for the direct drive engine, and is incorporated into the geared turbofan.

In another embodiment according to any of the previous embodiments, at least a portion of the high pressure compressor section, a combustor and the high pressure turbine section from the design of the direct drive engine would include at least 60% of the resulting parts in the high pressure compressor section, the combustor, and the high pressure turbine section of the direct drive engine, with a total part number counted to include hardware.

In another featured embodiment, a method of converting an aircraft engine, comprises the steps of removing, from an aircraft, an engine; removing, from the engine, a first low spool comprising a fan, a low pressure compressor and a low pressure turbine, wherein the fan and low pressure compressor of the first spool are configured to be driven by the low pressure turbine of the first spool at the same speed; and inserting, into the engine, a speed reduction mechanism and a second low spool comprising a fan, a low pressure compressor and a low pressure turbine, wherein the fan of the second low spool engages an output of the speed reduction mechanism such that the fan and low pressure compressor of the second low spool are configured to be driven the low pressure turbine of the first spool at different speeds.

These and other features may be best understood from the following drawings and specification.

### BRIEF DESCRIPTION OF THE DRAWINGS

FIG. 1 schematically shows an existing direct drive engine.

FIG. 2 shows a modified geared turbofan which incorporates portions of the FIG. 1 engine.

### DETAILED DESCRIPTION

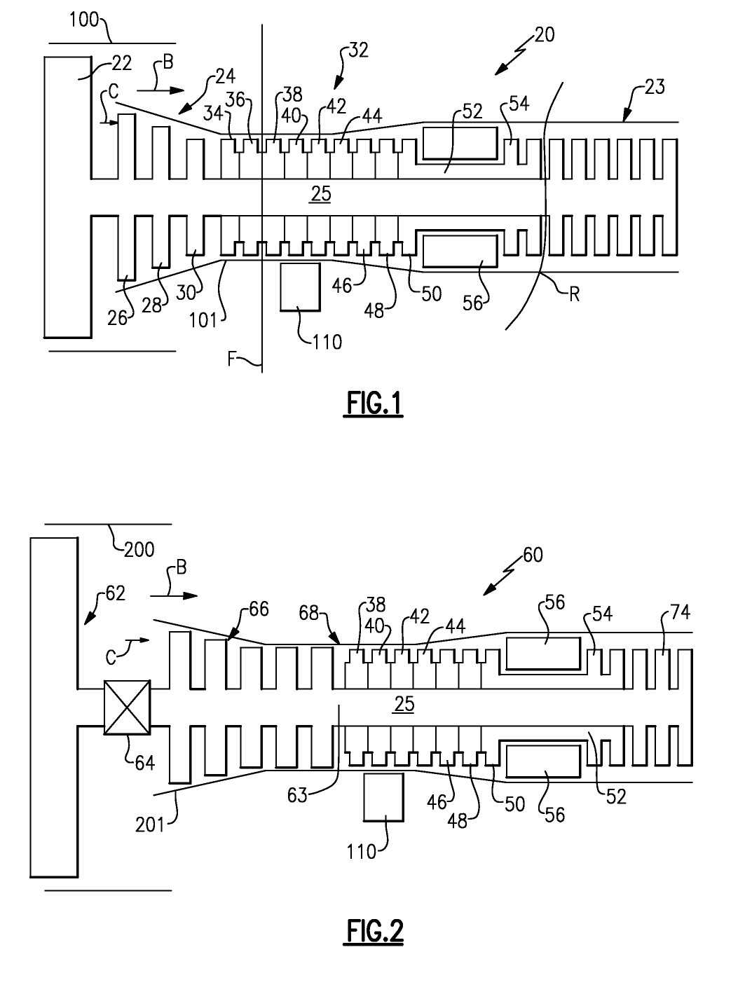

A direct drive engine 20 is illustrated in FIG. 1 and may be a known engine, which has been operational for any number of years. Engine 20 includes all of its components well developed and operational. Of course, an inventory of all components is well established.

In engine 20, a fan rotor 22 rotates with a low pressure compressor rotor 24. A fan rotor 22 rotates with a low pressure compressor rotor 24. The low pressure compressor rotor 24 is shown having three stages 26, 28 and 30. The fan rotor and the low pressure compressor rotor 24 rotate at a common speed with a shaft 25 driven by a low pressure turbine rotor 23. A high pressure compressor rotor 32 includes compressor stages 34, 36, 38, 40, 42, 44, 46, 48 and 50. Of course, other number of stages may come within the scope of this disclosure.

The air from the fan 22 is delivered within a bypass housing 100 as bypass air B and into the engine housing 101 as core airflow C. It should be understood that FIGS. 1 and 2 are very schematic and appropriate housing, etc., as known, would be included. In addition, any accessories, such as accessory gearboxes, oil, fuel supply systems, etc., would be incorporated into the engine 20 and are shown schematically at 110.

From the high pressure compressor rotor 32, the air is delivered into a combustion section 56. The high pressure compressor rotor 32 rotates with a shaft 52 which is driven by a high pressure turbine rotor 54.

An area R is rearward of the high pressure turbine rotor 54 and an area F forward of the intermediate stages of the high pressure compressor rotor 32 may be removed as explained below. A direct drive engine core is defined between areas F and R. It should be understood that while the line F is shown to be rearward of the high pressure compressor rotor stages 34 and 36, the line F could be moved forward of stages 34 and 36.

Applicant has recognized that the engine 20 is well developed and operational and has been so for any number of years. There is inventory stocked around the world and all of its components have been well designed.

Recently, the assignee of this Application has developed geared gas turbine engines where a gear reduction is placed between the fan drive turbine and the fan rotor. In this manner, the fan rotor may rotate at slower speeds relative to the low pressure compressor and low pressure turbine. A number of advantages flow from this modification.

However, such engines have not been operational for very long, and each new engine platform requires a redesign. Rather than a complete redesign, engine manufacturers could, during an overhaul procedure, modify a direct drive engine to provide a geared engine.

As such, Applicant proposes to utilize the direct drive core of the engine 20 in an overhaul type procedure to provide a geared turbofan engine 60 as illustrated in FIG. 2. The low spool, including the low pressure compressor rotor 66 and the low pressure turbine rotor 74, is changed or modified in the process. A gear reduction 64 is placed between the shaft 63 of the low pressure turbine rotor 74 and the fan rotor 62. The high pressure compressor rotor 68 may be modified, such as by eliminating one or two stages. On the other hand, fewer or more stages may be eliminated. Still, the remaining stages are as currently engineered and developed and, thus, the high pressure compressor rotor would require little or no engineering development, testing, etc. The combustor 56 and the high pressure turbine rotor 54 are as in the FIG. 1 engine.

In addition, some or all of the accessory gear boxes, oil and fuel supply systems, shown schematically at 110, may be utilized in the geared turbofan engine 60.

The fan rotor 62, as utilized in the engine 60, has a much larger diameter than the fan rotor 22. In addition, a bypass ratio may be defined for each engine 20 and 60. The bypass ratio is a ratio of the volume of air delivered as bypass air B compared to the volume of air delivered as core air C. The bypass ratio in the engine 60 may be greater than or equal to about 6.0. More narrowly, the bypass ratio in the engine 60 may be greater than or equal to about 10.0. In general, the bypass ratio for the engine 60 is larger than the bypass ratio for the engine 20.

The overhaul modification provides a geared engine 60 with an enormous reduction in required engineering design, testing, etc. In addition, much of the stocked inventory for the direct drive engine will remain useful, as many components may be shared between the engines 20 and 60.

The method disclosed in this application could be described as including the steps of modifying a direct drive engine 20, which includes a first fan rotor 22, a high pressure compressor 32 driven by a high pressure turbine 54 on a first high spool. A first low pressure turbine 23 is designed to drive a first low pressure compressor 24 on a first low spool. The first fan rotor 22 also rotates with the first low spool, and all at the same speed.

The method further includes a modifying step of providing a second fan rotor 62, a second low spool, including a second low pressure compressor rotor 66, and a second low pressure turbine rotor 74. A gear reduction 64 is incorporated between a shaft driven by the second low pressure turbine rotor 74 and the second fan rotor 62 to provide a geared turbofan 60. Thus, the method provides that at least a portion of the design of the high pressure compressor rotor, a combustor 56, and a high pressure turbine rotor 54 from a design direct drive engine are utilized in the geared turbofan.

Further, the method may include wherein the second low spool may be a replacement low spool. Alternatively, the second low spool may be a modification of the first low spool.

In embodiments, the resulting geared turbofan can have at least 60%, or more, identical parts as the original direct drive engine, with total parts counted across the high pressure compressor and turbine sections, and the combustion sections, and including hardware, such as bolts and nuts.

Although an embodiment of this invention has been disclosed, a worker of ordinary skill in this art would recognize that certain modifications would come within the scope of this invention. For that reason, the following claims should be studied to determine the true scope and content of this invention.

1. A method comprising the steps of:
modifying a direct drive engine, which includes a first fan rotor, a high pressure compressor driven by a high pressure turbine on a first high spool and a first low pressure turbine designed to drive a first low pressure compressor on a first low spool, and the fan rotor all at the same speed; and
said modifying step includes providing a second fan rotor, second low spool, including a second low pressure compressor rotor and second low pressure turbine rotor and incorporating a gear reduction between a shaft driven by the second low pressure turbine rotor and the second fan rotor to provide a geared turbofan,
such that at least a portion of the design of the high pressure compressor rotor, the combustor and the high pressure turbine rotor from the designed direct drive engine are utilized in the geared turbofan.

2. The method as set forth in claim 1, wherein said second low spool is a complete replacement of the first low spool.

3. The method as set forth in claim 1, wherein the second low spool is a modification of the first low spool.

4. The method as set forth in claim 1, wherein at least one stage is removed from said direct drive high pressure compressor rotor as designed to be utilized in said geared turbofan.

5. The method as set forth in claim 4, wherein at least one of an accessory gear box, an oil supply system and a fuel supply system is designed for said direct drive engine, and is incorporated into said geared turbofan.

6. The method as set forth in claim 5, wherein at least a portion of each of said accessory gear box, oil supply system, and fuel supply system as designed for the direct drive engine, is utilized in said geared turbofan.

7. The method as set forth in claim 4, wherein said second fan rotor has a diameter that is larger than said first fan rotor designed for said direct drive engine.

8. The method as set forth in claim 7, wherein a bypass ratio for said geared turbofan is greater than or equal to about 6.0.

9. The method as set forth in claim 8, wherein said bypass ratio is greater than or equal to about 10.0.

10. The method as set forth in claim 1, wherein at least one of an accessory gear box, an oil supply system and a fuel supply system is designed for said direct drive engine, and is incorporated into said geared turbofan.

11. The method as set forth in claim 1, wherein said new fan rotor has a diameter that is larger than said fan rotor designed for said direct drive engine.

12. The method as set forth in claim 1, wherein a bypass ratio for said geared turbofan is greater than or equal to about 6.0.

13. The method as set forth in claim 12, wherein said bypass ratio is greater than or equal to about 10.0.

14. The method as set forth in claim 1, wherein the high pressure compressor, high pressure turbine, and a combustion section on the direct drive engine provide at least 60% of the parts, defined as also including hardware, as a high pressure compressor, high pressure turbine, and combustion section in the resulting geared turbofan.

15. A gas turbine engine comprising:
a high pressure compressor driven by a high pressure turbine and a low pressure turbine driving a low pressure compressor and a fan rotor through a gear reduction, and a combustor; and
at least a portion of the high pressure compressor rotor, the combustor and the high pressure turbine rotor are from a design of a direct drive engine.

16. The gas turbine engine as set forth in claim 15, wherein at least one stage is removed from said direct drive high pressure compressor rotor as designed to be utilized in said geared turbofan.

17. The gas turbine engine as set forth in claim 15, wherein at least one of an accessory gear box, an oil supply system and a fuel supply system is designed for said direct drive engine, and is incorporated into said geared turbofan.

18. The gas turbine engine as set forth in claim 17, wherein at least a portion of each of said accessory gear box, oil supply system, and fuel supply system as designed for the direct drive engine, is utilized in said geared turbofan.

19. The gas turbine engine as set forth in claim 15, wherein a bypass ratio for said geared turbofan is greater than or equal to about 6.0.

20. The gas turbine engine as set forth in claim 19, wherein said bypass ratio is greater than or equal to about 10.0.

21. The gas turbine engine as set forth in claim 20, wherein at least one of an accessory gear box, oil supply system and a fuel supply system is designed for said direct drive engine, and is incorporated into said geared turbofan.

22. The gas turbine engine as set forth in claim 1, wherein said at least a portion of the high pressure compressor section, a combustor and the high pressure turbine section from the design of the direct drive engine would include at least 60% of the resulting parts in the high pressure compressor section, the combustor, and the high pressure turbine section of the direct drive engine, with a total part number counted to include hardware.

23. A method of converting an aircraft engine, comprising the steps of:
removing, from an aircraft, an engine;
removing, from the engine, a first low spool comprising a fan, a low pressure compressor and a low pressure turbine, wherein the fan and low pressure compressor of the first spool are configured to be driven by the low pressure turbine of the first spool at the same speed;
inserting, into the engine, a speed reduction mechanism and a second low spool comprising a fan, a low pressure compressor and a low pressure turbine, wherein the fan of the second low spool engages an output of the speed reduction mechanism such that the fan and low pressure compressor of the second low spool are configured to be driven the low pressure turbine of the first spool at different speeds.
